(19) United States
(12) Patent Application Publication
(10) Pub. No.: US 2024/0407285 A1
(43) Pub. Date: Dec. 12, 2024

(54) SMART PREDICTIVE CUT HEIGHT PER SPECIFIC CROP

(71) Applicant: CNH Industrial America LLC, New Holland, PA (US)

(72) Inventors: Garin Ingalls, New Holland, PA (US); Jeffrey Fay, II, New Holland, PA (US)

(73) Assignee: CNH Industrial America LLC, New Holland, PA (US)

(21) Appl. No.: 18/330,184

(22) Filed: Jun. 6, 2023

(51) Int. Cl. A01D 34/00; G06V 20/10; G06V 20/56

(52) U.S. Cl. CPC A01D 34/006; G06V 20/188; G06V 20/56

(57) ABSTRACT

A system includes a vehicle, a database, and a control system including processing circuitry. The processing circuitry is configured to receive an indication of a crop to be harvested, determine at least one attribute of the crop and a default setting of a parameter of the agricultural vehicle, at least one of the attribute of the crop or the default setting of the parameter being stored in the database, adjust the parameter of the agricultural vehicle to the default setting, the default setting based at least on the at least one attribute of the crop, operate the vehicle with the parameter at the default setting, receive an input of a user to adjust the setting of the parameter, store the adjusted setting of the parameter as a secondary setting, and upon thereafter receiving a second indication of the crop to be harvested, display the default setting and the secondary setting.

### BACKGROUND

Mowers are commonly used by farmers to harvest multiple types of crop. However, the cutting height of the mowers may not be optimal for all types of crops, as some crops may require a shorter or taller cutting height to achieve an optimal harvest when considering current yields and future crop growth. The decision of whether to cut the crops at the same height or at different heights depends on various factors, such as the current yield of the crop, the growth stage of the crop, and the potential impact on future crop growth. By considering the crop to be harvested, potential current yield, and future crop growth, operators must decide the cut height of the mower. However, many operators do not know the optimal height to harvest specific crops to maximize yield and plant health/growth.

### SUMMARY

One embodiment relates to a system. The system includes an agricultural vehicle, a database, and a control system. The control system includes processing circuitry configured to receive an indication of a crop to be harvested by the agricultural vehicle, determine at least one attribute of the crop to be harvested by the agricultural vehicle and a default setting of a parameter of the agricultural vehicle (at least one of the at least one attribute of the crop or the default setting of the parameter being stored in the database), adjust the parameter of the agricultural vehicle to the default setting, the default setting based at least on the at least one attribute of the crop to be harvested, operate the agricultural vehicle with the parameter at the default setting, receive an input of a user to adjust the setting of the parameter, store the adjusted setting of the parameter as a secondary setting, and upon thereafter receiving a second indication of the crop to be harvested, display the default setting and the secondary setting.

Another embodiment relates to a method. The method includes receiving, by a processing circuitry, an indication of a crop to be harvested by an agricultural vehicle, determining, by the processing circuitry, at least one attribute of the crop to be harvested by the agricultural vehicle and a default setting of a parameter of the agricultural vehicle, at least one of the at least one attribute of the crop or the default setting of the parameter being stored in a database, adjusting, by the processing circuitry, the parameter of the agricultural vehicle to the default setting, the default setting based at least on the at least one attribute of the crop to be harvested, operating, by the processing circuitry, the agricultural vehicle with the parameter at the default setting, receiving, by the processing circuitry, an input of a user to adjust the setting of the parameter, storing, by the processing circuitry, the adjusted setting of the parameter as a secondary setting and upon thereafter receiving, by the processing circuitry, a second indication of the crop to be harvested, displaying, by the processing circuitry, the default setting and the secondary setting.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a driveline of the vehicle of FIG. 1, according to an exemplary embodiment.

FIG. 4 is a schematic block diagram of a control system of the vehicle of FIG. 1, according to an exemplary embodiment.

FIG. 5 is a perspective view of the vehicle of FIG. 1 and a crop to be harvested, according to an exemplary embodiment.

FIG. 6 is a perspective view of the vehicle of FIG. 1 and a crop to be harvested, according to an exemplary embodiment.

FIG. 7 is a perspective view of the vehicle of FIG. 1 and a crop to be harvested, according to an exemplary embodiment.

FIG. 8 is a flow diagram of a process to adjust the height of an agricultural vehicle implement, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, the vehicle of the present disclosure includes tractive elements to propel the vehicle along a desired trajectory. In one embodiment, the vehicle is a self-propelled windrower (“SPW”) used in the harvest and cutting of various types of hay, forage, alfalfa, grasses, biomasses, wheat, oats, barley, etc. The SPW works by cutting the crop and then forming it into windrows, which are long rows of cut crops that are left to dry in the sun before being baled.

The windrower typically consists of a cutting bar or sickle bar, which is positioned at the front of the machine and is used to cut the crop. The cut crop then passes through a conditioning system, which may include rollers or flails, that help to break up the stems and leaves, making the crop easier to dry.

Once the crop is conditioned, it is then deposited onto a conveyor belt or rake, which forms it into windrows. The windrows are typically formed in a parallel pattern, with each windrow spaced a certain distance apart, depending on the crop and the desired drying time.

Some windrowers may also have additional features, such as an adjustable height control system that allows the operator to adjust the cutting height of the machine, or a swather attachment that can be used to spread the crop out even further for faster drying.

When harvesting, an operator of the SPW may wish to adjust the height of the header of the SPW through various actuators. Ensuring a proper header height is important because it affects the quality of the harvest. A header that is too low can potentially damage the crop, while a header that is too high may miss some of the crop. The height of the header should be adjusted to the height of the crop, but also to the terrain and current wind conditions. The height of the header should be adjusted frequently, as the crop height and terrain can change quickly.

The user may wish to adjust the height of the header to follow the terrain of the field being harvest. Often, fields contain terrain that rises and lowers, sometimes only on one side of a header. In such situations, a user may wish to adjust the height of the SPW header on only one side so as to follow the rising and lower terrain. Likewise, crops may grow at different heights within a field and the operator may wish to adjust the height of the header to follow the height of the crops, independent of the terrain.

While the user may wish to constantly be adjusting the height of the header during harvest, the user may face difficulties in deciding the initial starting height, based on the harvested crop. The height at which the crop is cut is an important factor in crop yield. The taller the crop, the more sunlight it can absorb and the more food it can produce. However, cutting too high may greatly reduce the amount of yield. Alternatively, cutting the crop too low can result in damage to the plant and stunt its growth and overall yield.

The optimum height to cut a crop varies depending on the type of crop, the climate, and the soil conditions. Some crops, such as wheat, may be better harvested at a higher height than others, such as barley. In some climates, such as dry climates, it is important to cut crops as high as possible to reduce water stress. The optimum harvest height for each crop at each climate zone or geographical location may be stored in a database to be accessed by a user.

According to an exemplary embodiment, the SPW may be in communication with the database housing the various crop, climate, and optimum harvest height information. The SPW may receive a selection of crop and geographic location from a user and query the database for an optimum height. Upon receiving the optimum height for the specified crop and corresponding location (including terrain, soil conditions, climate, weather, etc.), the SPW may automatically adjust the header height to the stored optimum harvest height. In some embodiments, the database contains information and models related to how to calculate an optimum harvest height, and a processor receives inputs from the user and information from the database to calculate an optimum harvest height based at least on the inputs of the user and the information in the database. The processor may be hosted by a server that is communicably coupled to the SPW. Alternatively, the processor may be hosted locally on the SPW and the optimum harvest height determination is made locally.

In some embodiments, the optimum height determination may be made by taking into account past and future climate predictions. For example, an optimal harvest height for wheat may be two-thirds the height of the wheat. However, in climate where no rain is predicted for the foreseeable future, the processor may determine that an optimal harvest height, when considering the rain forecast, may be three-quarters the height of the wheat.

Upon determining the optimum harvest height for a specific crop, for a specific climate, for a specific desired outcome (e.g., maximum yield, maximum growth, ground coverage for wildlife, insulation for winter, etc.), the processor may adjust the header to cut the crop at the optimum harvest height. This optimum harvest height may be considered the default height. However, a user may wish to adjust the height either at the beginning of the harvest or on-the-fly. The user may wish to set a custom height for a variety of reasons, including experience, if the SPW is harvesting two crops at the same time, personal preference, etc. In such cases, the user may manually override the default height and set a custom height of the header based on the user's previous inputs (e.g., crop type, climate, desired outcome, etc.) In this embodiment, the user may set this custom height to be stored in the database for future retrieval. In some embodiments, the database may be accessed by a plurality of agricultural vehicles.

While reference to an exemplary SPW is made when referring to the figures that follow, it should be understood that the embodiments and functionalities of the present disclosure may relate to a variety of agricultural implements and/or vehicles. For example, the present disclosure may relate to self-propelled mowers, towed mower-conditioners, side-pull mowers, center-pivot mowers, self-propelled mower-conditioners, etc.

### Overall Vehicle

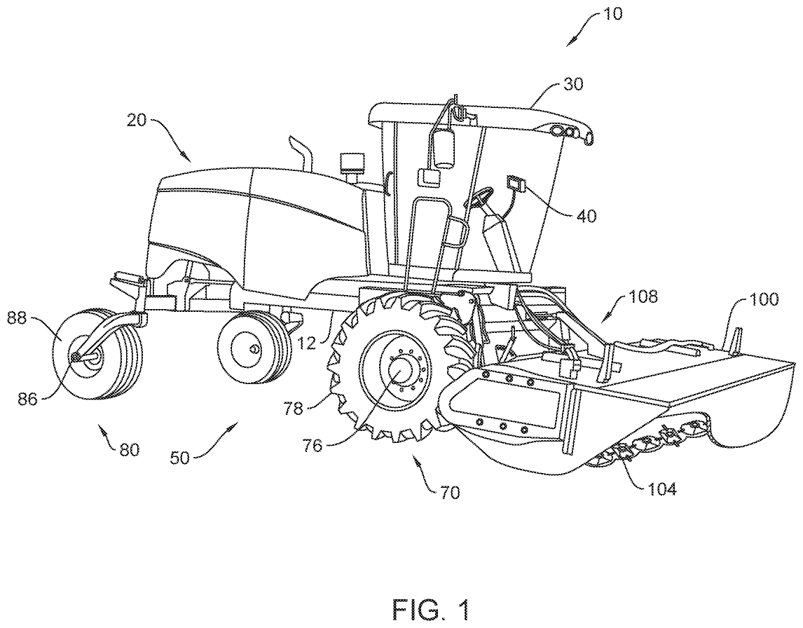

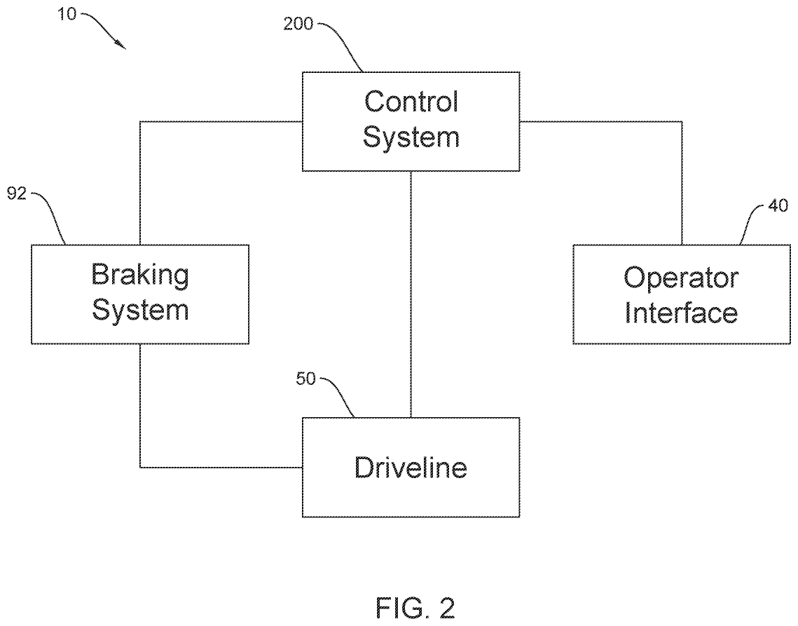

According to the exemplary embodiment shown in FIGS. 1-3, a machine or vehicle, shown as vehicle 10, includes a chassis, shown as frame 12; a body assembly, shown as body 20, coupled to the frame 12 and having an occupant portion or section, shown as cab 30; operator input and output devices, shown as operator interface 40, that are disposed within the cab 30; a drivetrain, shown as driveline 50, coupled to the frame 12 and at least partially disposed under the body 20; a vehicle braking system, shown as braking system 92, coupled to one or more components of the driveline 50 to facilitate selectively braking the one or more components of the driveline 50; and a vehicle control system, shown as control system 200, coupled to the operator interface 40, the driveline 50, and the braking system 92. In other embodiments, the vehicle 10 includes more or fewer components.

The chassis of the vehicle 10 may include a structural frame (e.g., the frame 12) formed from one or more frame members coupled to one another (e.g., as a weldment). Additionally or alternatively, the chassis may include a portion of the driveline 50. By way of example, a component of the driveline 50 (e.g., the transmission 56) may include a housing of sufficient thickness to provide the component with strength to support other components of the vehicle 10.

According to an exemplary embodiment, the vehicle 10 is an off-road machine or vehicle. In some embodiments, the off-road machine or vehicle is an agricultural machine or vehicle such as a tractor, a telehandler, a front loader, a combine harvester, a grape harvester, a forage harvester, a sprayer vehicle, a speedrower, and/or another type of agricultural machine or vehicle. In some embodiments, the off-road machine or vehicle is a construction machine or vehicle such as a skid steer loader, an excavator, a backhoe loader, a wheel loader, a bulldozer, a telehandler, a motor grader, and/or another type of construction machine or vehicle. In some embodiments, the vehicle 10 includes one or more attached implements and/or trailed implements such as a front mounted mower, a rear mounted mower, a trailed mower, a tedder, a rake, a baler, a plough, a cultivator, a rotavator, a tiller, a harvester, and/or another type of attached implement or trailed implement.

According to an exemplary embodiment, the cab 30 is configured to provide seating for an operator (e.g., a driver, etc.) of the vehicle 10. In some embodiments, the cab 30 is configured to provide seating for one or more passengers of the vehicle 10. According to an exemplary embodiment, the operator interface 40 is configured to provide an operator with the ability to control one or more functions of and/or provide commands to the vehicle 10 and the components thereof (e.g., turn on, turn off, drive, turn, brake, engage various operating modes, raise/lower an implement, etc.). The operator interface 40 may include one or more displays and one or more input devices. The one or more displays may be or include a touchscreen, a LCD display, a LED display, a speedometer, gauges, warning lights, etc. The one or more input device may be or include a steering wheel, a joystick, buttons, switches, knobs, levers, an accelerator pedal, a brake pedal, etc.

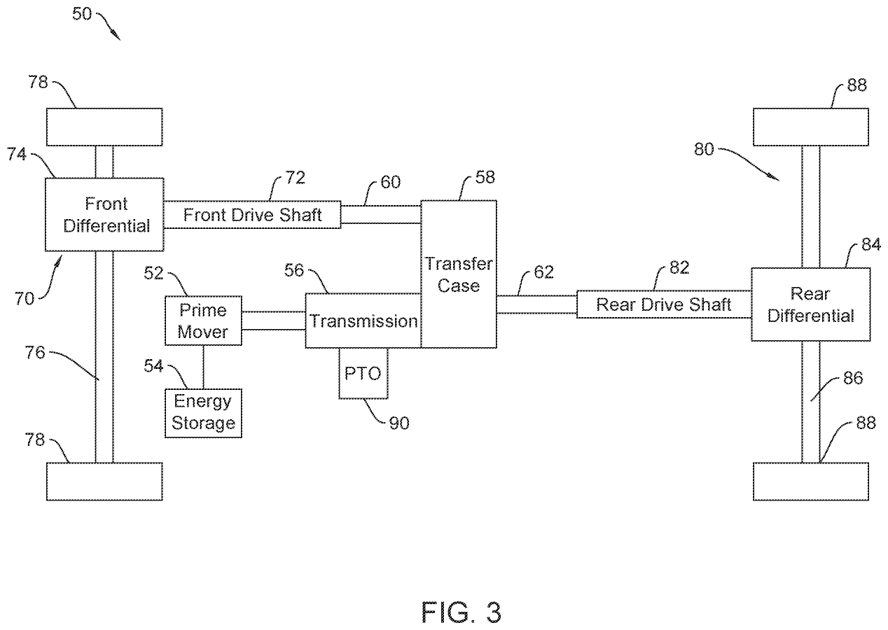

According to an exemplary embodiment, the driveline 50 is configured to propel the vehicle 10. As shown in FIG. 3, the driveline 50 includes a primary driver, shown as prime mover 52, and an energy storage device, shown as energy storage 54. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

As shown in FIG. 3, the driveline 50 includes a transmission device (e.g., a gearbox, a continuous variable transmission (“CVT”), etc.), shown as transmission 56, coupled to the prime mover 52; a power divider, shown as transfer case 58, coupled to the transmission 56; a first tractive assembly, shown as front tractive assembly 70, coupled to a first output of the transfer case 58, shown as front output 60; and a second tractive assembly, shown as rear tractive assembly 80, coupled to a second output of the transfer case 58, shown as rear output 62. According to an exemplary embodiment, the transmission 56 has a variety of configurations (e.g., gear ratios, etc.) and provides different output speeds relative to a mechanical input received thereby from the prime mover 52. In some embodiments (e.g., in electric driveline configurations, in hybrid driveline configurations, etc.), the driveline 50 does not include the transmission 56. In such embodiments, the prime mover 52 may be directly coupled to the transfer case 58. According to an exemplary embodiment, the transfer case 58 is configured to facilitate driving both the front tractive assembly 70 and the rear tractive assembly 80 with the prime mover 52 to facilitate front and rear drive (e.g., an all-wheel-drive vehicle, a four-wheel-drive vehicle, etc.). In some embodiments, the transfer case 58 facilitates selectively engaging rear drive only, front drive only, and both front and rear drive simultaneously. In some embodiments, the transmission 56 and/or the transfer case 58 facilitate selectively disengaging the front tractive assembly 70 and the rear tractive assembly 80 from the prime mover 52 (e.g., to permit free movement of the front tractive assembly 70 and the rear tractive assembly 80 in a neutral mode of operation). In some embodiments, the driveline 50 does not include the transfer case 58. In such embodiments, the prime mover 52 or the transmission 56 may directly drive the front tractive assembly 70 (i.e., a front-wheel-drive vehicle) or the rear tractive assembly 80 (i.e., a rear-wheel-drive vehicle).

As shown in FIGS. 1 and 3, the front tractive assembly 70 includes a first drive shaft, shown as front drive shaft 72, coupled to the front output 60 of the transfer case 58; a first differential, shown as front differential 74, coupled to the front drive shaft 72; a first axle, shown front axle 76, coupled to the front differential 74; and a first pair of tractive elements, shown as front tractive elements 78, coupled to the front axle 76. In some embodiments, the front tractive assembly 70 includes a plurality of front axles 76. In some embodiments, the front tractive assembly 70 does not include the front drive shaft 72 or the front differential 74 (e.g., a rear-wheel-drive vehicle). In some embodiments, the front drive shaft 72 is directly coupled to the transmission 56 (e.g., in a front-wheel-drive vehicle, in embodiments where the driveline 50 does not include the transfer case 58, etc.) or the prime mover 52 (e.g., in a front-wheel-drive vehicle, in embodiments where the driveline 50 does not include the transfer case 58 or the transmission 56, etc.). The front axle 76 may include one or more components.

As shown in FIGS. 1 and 3, the rear tractive assembly 80 includes a second drive shaft, shown as rear drive shaft 82, coupled to the rear output 62 of the transfer case 58; a second differential, shown as rear differential 84, coupled to the rear drive shaft 82; a second axle, shown rear axle 86, coupled to the rear differential 84; and a second pair of tractive elements, shown as rear tractive elements 88, coupled to the rear axle 86. In some embodiments, the rear tractive assembly 80 includes a plurality of rear axles 86. In some embodiments, the rear tractive assembly 80 does not include the rear drive shaft 82 or the rear differential 84 (e.g., a front-wheel-drive vehicle). In some embodiments, the rear drive shaft 82 is directly coupled to the transmission 56 (e.g., in a rear-wheel-drive vehicle, in embodiments where the driveline 50 does not include the transfer case 58, etc.) or the prime mover 52 (e.g., in a rear-wheel-drive vehicle, in embodiments where the driveline 50 does not include the transfer case 58 or the transmission 56, etc.). The rear axle 86 may include one or more components. According to the exemplary embodiment shown in FIG. 1, the front tractive elements 78 and the rear tractive elements 88 are structured as wheels. In other embodiments, the front tractive elements 78 and the rear tractive elements 88 are otherwise structured (e.g., tracks, etc.). In some embodiments, the front tractive elements 78 and the rear tractive elements 88 are both steerable. In other embodiments, only one of the front tractive elements 78 or the rear tractive elements 88 is steerable. In still other embodiments, both the front tractive elements 78 and the rear tractive elements 88 are fixed and not steerable.

In some embodiments, the driveline 50 includes a plurality of prime movers 52. By way of example, the driveline 50 may include a first prime mover 52 that drives the front tractive assembly 70 and a second prime mover 52 that drives the rear tractive assembly 80. By way of another example, the driveline 50 may include a first prime mover 52 that drives a first one of the front tractive elements 78, a second prime mover 52 that drives a second one of the front tractive elements 78, a third prime mover 52 that drives a first one of the rear tractive elements 88, and/or a fourth prime mover 52 that drives a second one of the rear tractive elements 88. By way of still another example, the driveline 50 may include a first prime mover that drives the front tractive assembly 70, a second prime mover 52 that drives a first one of the rear tractive elements 88, and a third prime mover 52 that drives a second one of the rear tractive elements 88. By way of yet another example, the driveline 50 may include a first prime mover that drives the rear tractive assembly 80, a second prime mover 52 that drives a first one of the front tractive elements 78, and a third prime mover 52 that drives a second one of the front tractive elements 78. In such embodiments, the driveline 50 may not include the transmission 56 or the transfer case 58.

As shown in FIG. 3, the driveline 50 includes a power-take-off (“PTO”), shown as PTO 90. While the PTO 90 is shown as being an output of the transmission 56, in other embodiments the PTO 90 may be an output of the prime mover 52, the transmission 56, and/or the transfer case 58. According to an exemplary embodiment, the PTO 90 is configured to facilitate driving an attached implement and/or a trailed implement of the vehicle 10. In some embodiments, the driveline 50 includes a PTO clutch positioned to selectively decouple the driveline 50 from the attached implement and/or the trailed implement of the vehicle 10 (e.g., so that the attached implement and/or the trailed implement is only operated when desired, etc.).

According to an exemplary embodiment, the braking system 92 includes one or more brakes (e.g., disc brakes, drum brakes, in-board brakes, axle brakes, etc.) positioned to facilitate selectively braking (i) one or more components of the driveline 50 and/or (ii) one or more components of a trailed implement. In some embodiments, the one or more brakes include (i) one or more front brakes positioned to facilitate braking one or more components of the front tractive assembly 70 and (ii) one or more rear brakes positioned to facilitate braking one or more components of the rear tractive assembly 80. In some embodiments, the one or more brakes include only the one or more front brakes. In some embodiments, the one or more brakes include only the one or more rear brakes. In some embodiments, the one or more front brakes include two front brakes, one positioned to facilitate braking each of the front tractive elements 78. In some embodiments, the one or more front brakes include at least one front brake positioned to facilitate braking the front axle 76. In some embodiments, the one or more rear brakes include two rear brakes, one positioned to facilitate braking each of the rear tractive elements 88. In some embodiments, the one or more rear brakes include at least one rear brake positioned to facilitate braking the rear axle 86. Accordingly, the braking system 92 may include one or more brakes to facilitate braking the front axle 76, the front tractive elements 78, the rear axle 86, and/or the rear tractive elements 88. In some embodiments, the one or more brakes additionally include one or more trailer brakes of a trailed implement attached to the vehicle 10. The trailer brakes are positioned to facilitate selectively braking one or more axles and/or one more tractive elements (e.g., wheels, etc.) of the trailed implement.

According to one embodiment, the vehicle 10 is an SPW and includes a header 100. The header 100 is the front portion of the SPW. It is made of various components including at least one cutting disc 104, used to cut the crop. The header may also include a conditioner, used to crimp and lay down the cut crop in a way to decrease drying time. The header may include lifting mechanisms 108 to raise and lower the header to achieve different heights of cut. Lifting mechanism 108 may be electric, hydraulic, mechanical or pneumatic. In some embodiments, the vehicle 10 is a tractor and the header is a towed mower-conditioner (e.g., a side-pull mower or center-pivot mower).

### Automatic Height Adjustment

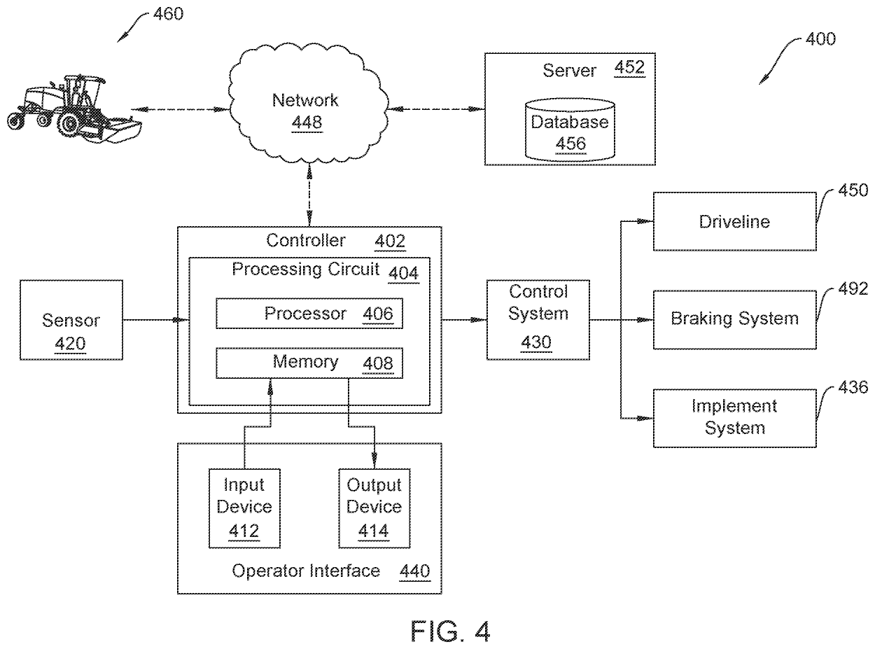

Turning now to FIGS. 4-8, a system for adjusting the height of a mower-conditioner header or other mowing implement. Referring to FIG. 4, a height adjustment system 400 is shown. The height adjustment system 400 includes a controller 402. The controller 402 may be configured to control the operation of a header/cutting height, roll angle, and tilt angle. The controller 402 includes a processing circuit 404, which includes a processor 406 and a memory 408. The memory 408 may contain one or more instructions that, when executed by the processor 406, caused the processor 406 to perform one or more of the actions described herein. In some embodiments the memory 408 is in communication with the processor 406. The height adjustment system 400 further includes at least one sensor 420, that is operatively coupled to the controller 402. In some embodiments, the sensor 420 is configured to provide a signal indicating the current height and angle of the SPW header 100 of FIG. 1. The sensor 420 may measure the height of the header 100 through a variety of methods. For example, the sensor 420 may use image data collected from the sensor 420 to analyze the height of the header 100 in relation to a known reference point (e.g., a point on a vehicle associated with the header, a point on the ground, etc.). In some embodiments, the sensor 420 may utilize pressure sensors in contact with the ground to measure the height of the header 100. In another embodiment, the sensor 420 may measure position of the lifting mechanism 108 to determine the height of the header 100. For example, the sensor 420 may measure, by potentiometer, the variable voltage corresponding to a position of the lifting mechanism 108. Alternatively, the sensor 420 may indicate the height of the header 100 indirectly through the user's set point of the header 100 height. In a pulled-mower embodiment (e.g., side-pull or center-pivot), the controller 402 may be on the vehicle towing the mower conditioner (e.g., a tractor). In other embodiments, the controller 402 may be housed on the implement itself.

The height adjustment system 400 also includes operator interface 440. The operator interface 440 includes, for example, an input device 412 and an output device 414. In some embodiments, the input device 412 and output device 414 are communicably coupled. The input device 412 is also communicably coupled to the controller 402. The output device 414 is also communicatively coupled to the controller 402. The input device 412 is configured to receive input from a user operating vehicle 10 of FIG. 1. The operator interface 440 may include one or more input devices 412 configured to receive an input from the user. By way of example the user interface 440 may include one or more switches, knobs, dials, styluses, touch screens, microphones, or other input devices. The output device 414 may include one or more output devices configured to provide information to the user. By way of example, the output device 414 may include one or more screens, lights, speakers, haptic feedback devices, or other output devices. In some embodiments the operator interface 440 is positioned within the cab 30, such that the user can interact with the user interface 440 to control the vehicle 10 while positioned within the cab 30.

In some embodiments, the controller 402 is configured to output instructions to adjust settings of the vehicle 10. These settings may be associated with the driveline 450, the braking system 492, or the implement system 436. In some embodiments, the driveline 450 includes a transmission, a differential, a propulsion device, a four-wheel drive, an auger speed, and a power takeoff system. In some embodiments the implement system 436 includes the SPW header 100. In other embodiments the implement system 436 include various other implements (for example, a bailer, a rake, a trailer, a plow, plough, a planter, a speedrower, side-pull mower conditioner, a center-pivot mower conditioner, etc.).

In some embodiments, the height adjustment system 400 includes a remote network 448 through which to communicate with various remote devices and servers communicably coupled to the network 448. According to an embodiment, the controller 402 is communicably coupled to the network 448, wherein a server 452 is also communicably coupled to network 448. In some embodiments, the server 452 hosts a database 456 which stores information related to crop harvesting. Such information may include calculations and formulas to determine optimum harvest height of various crops based on a variety of conditions. The database 456 may also include climate information, geographical information, user preferences, botanical information, etc. The database 456 may also store optimum harvest heights of various crops. In other embodiments the database 456 is stored in locally in memory 408. The memory 408 may include instructions, that when executed by the processor 406, output an optimum harvest height of a crop based on information hosted on database 456.

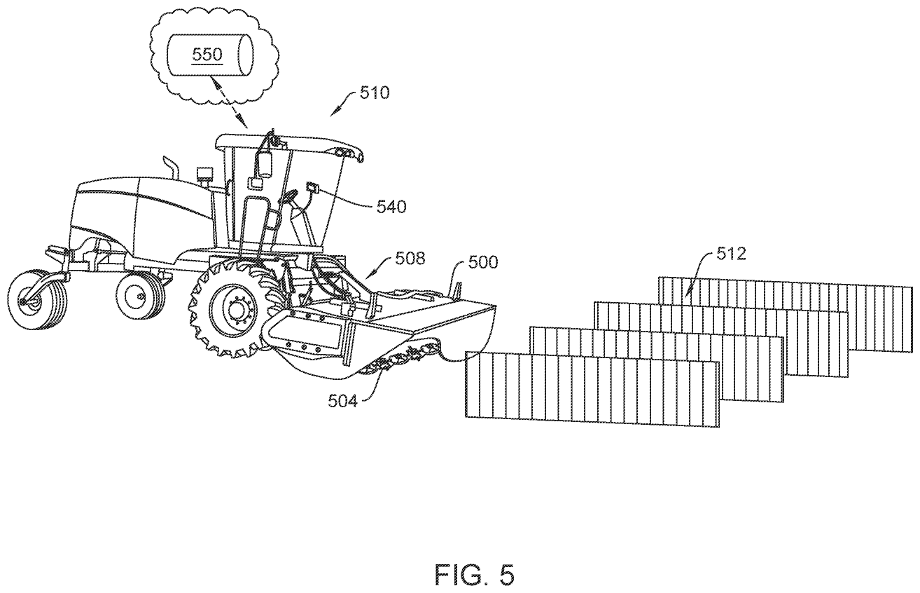

Referring now to FIG. 5, an SPW 510 with an SPW header 500 (including cutting disk 504), the SPW 510 using the height adjustment system 400 of FIG. 4. However, it should be noted that any mower-conditioner may be used to in implementing the present embodiments of FIGS. 1-7. Upon starting the harvesting of crop 512, the user inputs various data into operator interface 440, the operator interface communicably coupled with the processor 406. For example, the user may input a crop type, a crop height, a humidity, a time of year, a desired outcome, etc. The processor may then access database 456 to retrieve information stored therein to calculate (or otherwise access), and output, an optimum harvest height. Upon calculating the optimum harvest height, the processor transmits the optimum harvest height to a control system (e.g., control system 430 of FIG. 4). The control system 430 then generates a control signal to adjust one or more settings of the driveline 450, braking system 492, or the implement system 436. In some embodiments, control system adjusts the SPW header 500 height to cut the crop at the optimum harvest height. The control signal may be sent to the lifting mechanism 508 to adjust the height of the SPW header 500. In some embodiments the user may wish to adjust the cutting height from a default optimum harvest height generated by the processor 406 to a custom harvest height. In such embodiments the user may input an adjusted height into operator interface 440 (e.g., operator interface 540) through input device 412. The adjusted height may be transmitted to the controller 402, which sends the adjusted height value to control system 430, which generates and transmits a control signal to lifting mechanism 508 to adjust the height of the SPW header 500. In other embodiments, the control signal may be to adjust other settings of the SPW header 500, for example, roll angle, roller speed, tilt angle, disc speed, roll gap, roll tension, etc. The controller 402, by the processor 406, may also transmit the adjusted harvest height to database 456 to save the user inputted adjusted height as a custom height for the specified conditions. This custom height may be accessed by any processor communicatively coupled to database 550. This may include a fleet of SPWs 460 which are all communicatively coupled to database 456 through network 448.

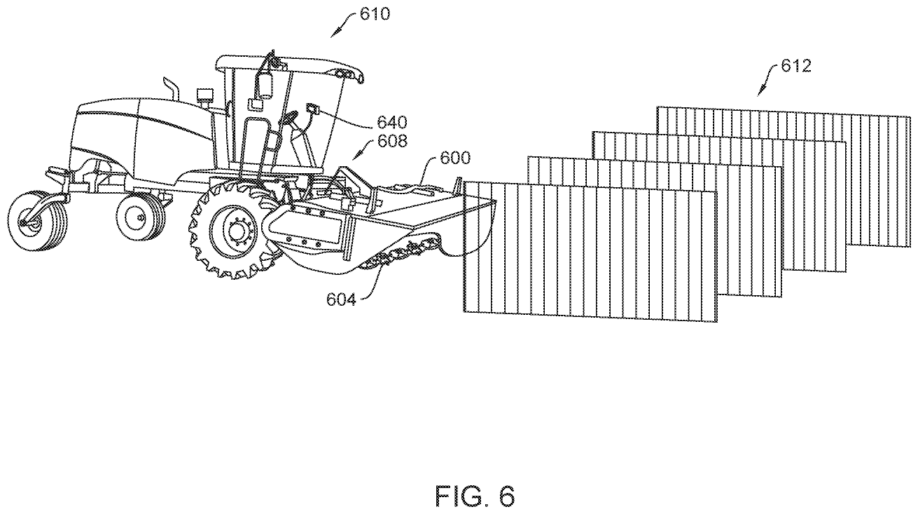

Referring now to FIG. 6, SPW 610 with an SPW header 600 (including cutting disk 604) is shown harvesting crop 612. The SPW 610 may include the height adjustment system 400 of FIG. 4. In some embodiments, crop 612 may be the same type as crop 512. In some embodiments, crop 612 may be a different type as crop 512. Upon beginning harvesting or cutting, the user may again input various data associated with the crop 612 and harvest generally (e.g., type, age, stalk diameter, moisture content, climate, geography, soil conditions, color, time of year, number of previous harvests, number or desired harvests, temperature, etc.) into operator interface 440 (e.g., operator interface 640). Processor 406 outputs a default optimum harvest height and sets the SPW header 600 to the default optimum harvest height and cutting angle (e.g., roll or tilt) with lifting mechanism 608. If the database 456 or memory 408 is storing a custom harvest height previously entered by the user, the output device 414 (e.g., a display screen) may display and present both the default optimum harvest height and the custom harvest height to the user to select which height to set the SPW header 600.

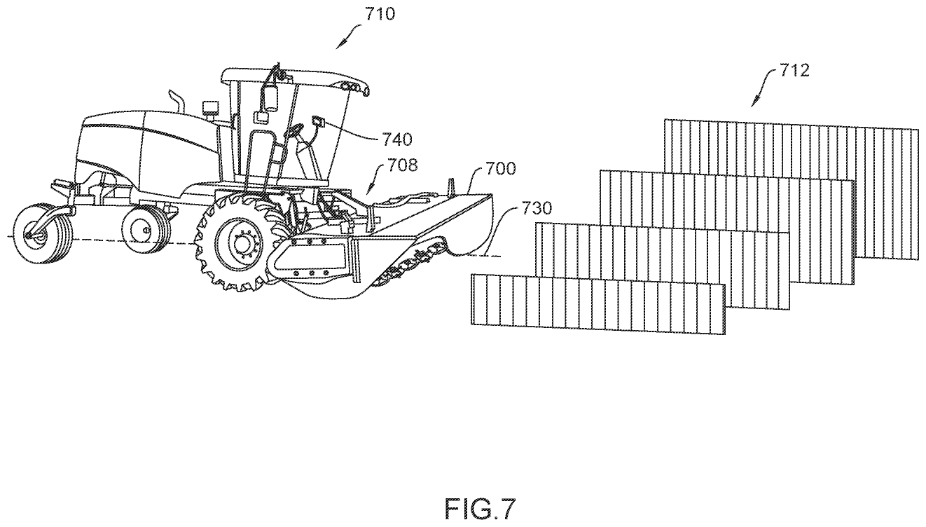

Referring now to FIG. 7, an SPW 710 with an SPW header 700 and operator interface 740 is shown harvesting crop 712. The SPW 710 may include the height adjustment system 400 of FIG. 4. In some embodiments, crop 712 may be the same type as crop 512. In some embodiments, crop 712 may be a different type as crop 512. Upon beginning harvesting, the user may again input various data associated with the crop 712 and harvest generally (e.g., type, age, stalk diameter, moisture content, climate, geography, soil conditions, color, time of year, number of previous harvests, number or desired harvests, etc.). In FIG. 7, crop 712 is shown as tapering from one end of the field to another. In an embodiment when the crop 712 is growing at different rates, the SPW header 700 may be configured to pivot about pivot axis 730. In substantially the same manner as described in FIGS. 5-6, the operator may select a harvest height (either the default optimum harvest height as outputted by the processor 406, or a custom harvest height as previously entered). If the crop 712 is tapered across the field, the control system 430 may transmit control signals to SPW header 700 to pivot about pivot axis 730 and raise/lower lifting mechanism 708 to cut the crop 712 at the selected height, independent of terrain or growth disparities between plants.

For example, dry spots in a field can produce crops 712 that grow much slower than crops 712 just a few feet away in the field with better moisture content. As a result, the crops 712 in the dry spot will be shorter at the time to harvest. As SPW 710 harvests or cuts crop 712 according to the selected harvest height, the sensor 420 may transmit image data to processor 406 to analyze the image data and output an indicated adjustment needed to be made to the SPW header 700 to maintain a constant harvest height. This indicated adjustment is sent to control system 430 which in turn transmits control signals to driveline 450, braking system 492, or implement system 436 to adjust the harvest height in relation to the height of crop 712.

In some embodiments, the processor need not use image data from sensor 420, in other embodiments, processor uses sensor data from sensor 420 to calculate the contours of the field. In such embodiments, the processor may use the calculated contours of the field to pivot and raise/lower the SPW header 700 in relation to the changes in elevation of the fields in real-time. It should be understood that height adjustment system 400 may include more than one sensor 420, wherein each sensor 420 may provide different data to processor 406 (e.g., image, SPW header 700 position, ground speed of SPW 710, reel speed, knife speed, roll tension, roll gap, etc.). In some embodiments, the processor may output directions to adjust the SPW header 700 position in relation to both the crop 712 height and changes in elevation of the field.

While the embodiments described in FIGS. 5-7 generally discuss adjustments to the height of the SPW header 500, 600, 700, it should be understood that the processor may adjust various parameters of the driveline 450, braking system 492, and implement system 436 (e.g., disc speed) to achieve an optimal harvest, when considering both current yield and future growth. In such embodiments, the processor 406 may use information from database 456 to determine the default parameter settings to achieve an optimal harvest. In some embodiments, the functions and embodiments may be applied to mower-conditions, such as side-pull mowers and center-pivot mowers. The processor may adjust parameters of these implements as well. These parameters may include ground speed, roll gap, roll tension, reel speed, etc.

The roll gap on a mower conditioner refers to the distance between the upper and lower conditioning rolls. The conditioning rolls are used to crimp or crush the cut crop to help speed up the drying process.

The roll gap on a mower conditioner is adjusted to achieve an effective crop conditioning and a high-quality cut. A smaller roll gap produces a more aggressive crimping or crushing action, which can help to speed up the drying process but may also increase the risk of damage to the conditioning rolls. A larger roll gap produces a milder conditioning action, which may be better suited for crops that are more delicate or require less aggressive conditioning.

The specific roll gap setting for a mower conditioner depends on a variety of factors, such as the type and moisture content of the crop, the desired level of conditioning, and the condition of the conditioning rolls and counter knife.

In some embodiments, the control system 430 may send control signals to various actuators to adjust the roll gap during operation. The roll gap is typically monitored by a sensor (e.g., sensor 420) on the SPW. This sensor transmits a signal to the processor 406, which adjusts the roll gap as needed to maintain the correct roll gap.

The roll gap is an important factor in crop yield. A wider the roll gap results in a longer the dry-down time. The narrower the roll gap, the more crop will be damaged. It is important to find the correct roll gap for the type of crop being harvested and the conditions of the field. In some embodiments, processor 406 uses sensor data from sensor 420 to measure crop yield. Processor 406 may then calculate or generate the optimum roll gap for an optimum harvest and send an indication of the optimum roll gap to the control system 430 to transmit a control signal to the implement system to adjust the roll gap to the optimum roll gap. Just as with the default optimum harvest height, the user may override the default optimum roll gap to set a custom roll gap. This custom roll gap is saved in database 456 to be presented to the user or other operators upon a subsequent harvest cycle with similar harvest parameters as input by the user.

Roll tension on a mower conditioner refers to the force applied to the conditioning rolls to maintain a proper biasing force of one roll to the other, such as the top roll biased toward the bottom roll. The conditioning rolls are used to crimp or crush the cut crop to help speed up the drying process, while the counter knife or bedknife is a stationary blade that helps to maintain a uniform cutting height.

Roll tension is a factor in achieving effective conditioning and a high-quality cut. Too little tension can result in poor crimping or crushing of the crop, while too much tension can cause excessive wear and damage to the conditioning rolls.

The specific roll tension setting for a mower conditioner depends on a variety of factors, such as the type and moisture content of the crop, the desired level of conditioning, and the condition of the conditioning rolls.

Roll tension can be adjusted using the roll tension adjustment mechanism on the mower conditioner. This mechanism typically consists of a set of springs or hydraulic cylinders that apply force to the conditioning rolls. The roll tension can be adjusted by increasing or decreasing the tension applied by the springs or hydraulic cylinders. The roll tension is typically monitored by a sensor (e.g., sensor 420) on the mower conditioner. This sensor sends a signal to the processor 406, which may adjust the tensioning system as needed to maintain the correct roll tension.

The roll tension is an important factor in crop yield. The correct roll tension will allow the mower conditioner to harvest the crop evenly and efficiently. In some embodiments, processor 406 uses sensor data from sensor 420 to measure crop yield. Processor 406 may then calculate or generate the optimum roll tension for an optimum harvest and send an indication of the optimum roll tension to the control system 430 to transmit a control signal to the implement system to adjust the roll tension to the optimum roll tension. Just as with the default optimum harvest height, the user may override the default optimum roll tension to set a custom roll tension. This custom roll gap is saved in database 456 to be presented to the user or other operators upon a subsequent harvest cycle with similar harvest parameters as input by the user.

The disc speed of an SPW is the speed at which the discs rotate that cut the crop. The disc speed is typically measured in revolutions per minute (RPM). The disc speed is an important factor in crop yield. The higher the disc speed, the more crop will be cut per minute. However, too high of a disc speed can damage the crop. The disc speed is typically adjusted by a series of levers or buttons (e.g., input device 412) on the SPW. The operator can adjust the disc speed to the correct speed for the type of crop being harvested and the conditions of the field.

In some embodiments, processor 406 uses sensor data from sensor 420 to measure crop yield. Processor 406 may then calculate or generate the optimum disc speed for an optimum harvest and send an indication of the optimum disc speed to the control system 430 to transmit a control signal to the implement system to adjust the disc speed to the optimum disc speed. Just as with the default optimum harvest height, the user may override the default optimum disc speed to set a custom disc speed. This custom roll gap is saved in database 456 to be presented to the user or other operators upon a subsequent harvest cycle with similar harvest parameters as input by the user.

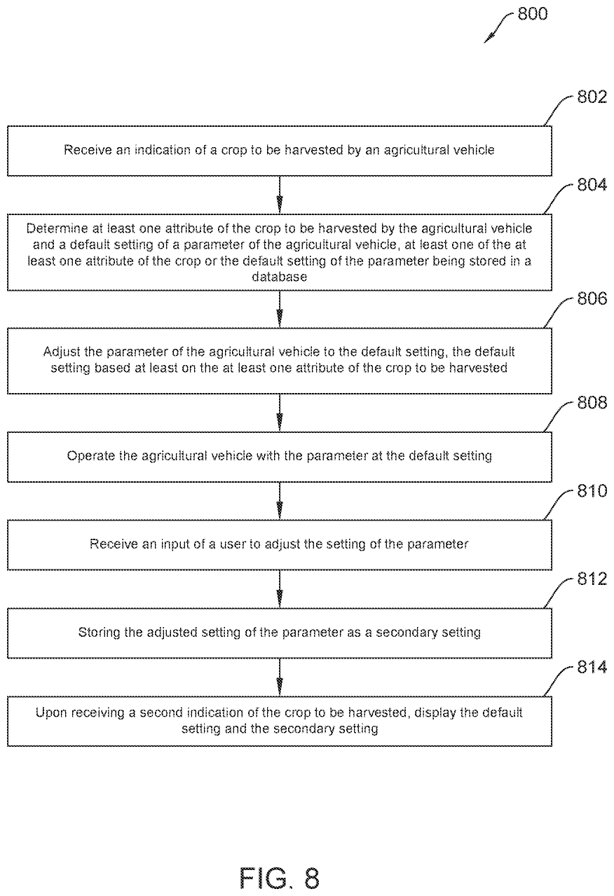

Referring now to FIG. 8, a flow diagram of a process 800 for adjusting the height of an SPW header according to the steps 802-814. In some embodiments, the process 800 is performed by an operator of the agricultural vehicle. In other embodiments, the process 800 is performed autonomously by a controller utilizing a neural network or a machine learning model. The neural network may be housed locally on the agricultural vehicle or, alternatively, the neural network may be housed remotely and be in communication with the agricultural vehicle wirelessly through the use of various wireless communication protocols, including, but not limited to, Wi-Fi, cellular, Bluetooth, etc.

Process 800 includes receiving an indication of a crop to be harvested by an agricultural vehicle (step 802) determining at least one attribute of the crop to be harvested by the agricultural vehicle and a default setting of a parameter of the agricultural vehicle, at least one of the at least one attribute of the crop or the default setting of the parameter being stored in a database (step 804), adjusting the parameter of the agricultural vehicle to the default setting, the default setting based at least on the at least one attribute of the crop to be harvested (step 806), operating the agricultural vehicle with the parameter at the default setting (step 808), receiving an input of a user to adjust the setting of the parameter (step 810), storing the adjusted setting of the parameter as a secondary setting (step 812), and upon thereafter receiving a second indication of the crop to be harvested, displaying the default setting and the secondary setting (step 814).

Step 802 includes receiving an indication of a crop to be harvested by an agricultural vehicle, according to some embodiments. In some embodiments, an operator of the agricultural vehicle may indicate a crop to be harvested by the agricultural vehicle. In some embodiments, the agricultural vehicle is an SPW. SPWs are a type of agricultural machine used for harvesting hay, straw, or other crops by cutting and conditioning the crop and forming it into windrows for drying. Unlike traditional windrowers that are towed behind a tractor, a self-propelled windrower is a standalone machine that is designed to be driven by an operator.

Self-propelled windrowers typically consist of a cutting and conditioning system mounted on a chassis with a cab for the operator. The cutting and conditioning system includes a sickle bar or disc mower for cutting the crop, followed by a conditioning system that crimps or crushes the crop to help speed up the drying process. The conditioned crop is then formed into windrows using a rake or other mechanism.

In some embodiments, the agricultural vehicle is a tractor coupled to a mower conditioner, such as a side-pull mower or a center-pivot mower. A mower conditioner is a type of agricultural machine used for harvesting hay, straw, or other crops by cutting and conditioning the crop to help speed up the drying process.

The cutting mechanism of a mower conditioner may be similar to that of a standard mower, using a reel or sickle bar to cut the crop. However, the mower conditioner also includes a conditioning system that crimps or crushes the crop to help break open the stems and speed up the drying process. This conditioning system can consist of one or more sets of conditioning rolls or flails, depending on the specific model.

The conditioned crop is then formed into windrows for drying, typically using a rake or other mechanism. Once the crop is sufficiently dry, it can be baled or stored for later use.

In some embodiments, the agricultural vehicle is a combine harvester. Combines are versatile machines that can harvest a wide range of crops, including: wheat, corn, soybeans, rice, barley, oats, rye, sunflowers, canola, peanuts, cotton, lentils, flax, sorghum, and millet. Combines can also be adapted with different headers or attachments to harvest other crops, such as grapes, olives, and fruits. A user may use any variety of input devices in communication with the combine harvester to indicate which crop is to be harvested. These input devices may include a keyboard, mouse, touchpad, joystick, scanner, microphone, webcam, graphics tablet, buttons, dials, knobs, a touch screen, and barcode scanner.

In some embodiments, the operator may indicate multiple crops to be harvested at a time. In some embodiments, the combine can harvest two types of crops at the same time if the crops are growing close to each other, and the combine is equipped with a special attachment “dual crop header.” A dual crop header may have two or more cutting units that can cut multiple rows of crops at the same time. For example, a combine with a dual crop header can harvest soybeans and corn that are planted in alternating rows. The cutting units are set at different heights to cut each crop at the appropriate level, and the harvested crops are then separated using the combine's internal mechanisms. This may be beneficial to the operating because harvesting two crops at the same time can increase efficiency and reduce costs, as it eliminates the need for separate harvesting operations.

Step 804 includes determining at least one attribute of the crop to be harvested by the agricultural vehicle and a default setting of a parameter of the agricultural vehicle, at least one of the at least one attribute of the crop or the default setting of the parameter being stored in a database, according to some embodiments. Once the operator has indicated the crop(s) to be harvested, an attribute of the crop to be harvested is determined by accessing information in a database 456. This data may be gathered from the internet, input by the operator, input by other operators, or otherwise. In some embodiments, the database hosts agricultural knowledge associated with harvesting crops by an SPW or towed mower conditioner. In some embodiments, a processor of the SPW makes the determination of the at least one attribute, in other embodiments, a processor hosted remotely and in communication with the SPW makes this determination. The attribute of the crop may include characteristics such as a density of the crop, a moisture level of the crop, a height of the crop, a stalk diameter of the crop, a germination period of the crop, an age of the crop, an angle of the crop (e.g., due to wind), a color of the crop, a spacing of the crop, a movement of the crop (e.g., due to wind or the vehicle), a root depth of the crop, the species of the crop, a growth stage of the crop, a structural integrity of the crop, a calculated harvest loss, a planted date, soil fertilizer content, a temperature (e.g., of the crop or the weather), or any attribute described herein. Alternatively, localized attributes of the specific field associated with the crop may be determined. For example, the processor may determine soil conditions, weather experienced by the crop, chemicals applied to the crop (either by spraying or otherwise), and other factors that may affect the harvesting process. The parameter of the agricultural vehicle may include settings such as a speed of the vehicle, the height of the cutting blade, a speed of the reel, a reel gap, a reel tension, a disc speed, header position/angle, and other factors that may affect the efficiency and effectiveness of the harvesting process.

Once the attribute of the crop and the default setting of the parameter of the agricultural vehicle have been determined, at least one of these parameters is stored in a database. By storing this information, the agricultural vehicle can use the same settings in subsequent harvesting operations, or these settings can be adjusted based on the feedback received from previous operations. The database can also be used to track and analyze the performance of the agricultural vehicle and make adjustments to improve its efficiency and effectiveness over time.

The default setting of the parameter can be determined based on a variety of factors, including the type of crop, the moisture level of the crop, the density of the crop, and the stage of growth of the crop. These factors can influence the vehicle's performance and impact the quality of the harvested crop.

Step 806 includes adjusting the parameter of the agricultural vehicle to the default setting, the default setting based at least on the at least one attribute of the crop to be harvested, according to some embodiments.

In certain embodiments, once the controller determines at least one attribute of the crop to be harvested, it adjusts the parameter of the agricultural vehicle to the default setting. The default setting is based at least on the determined attribute of the crop to be harvested. For example, if the crop is wheat and it is determined that the crop is at a certain moisture level, the default setting of the parameter can be adjusted to ensure optimal harvesting conditions.

By adjusting the vehicle's parameter settings to the default setting based on the determined crop attributes, the operator ensures that the agricultural vehicle operates efficiently and produces optimum harvests, when considering current yield and future crop growth.

Step 808 includes operating the agricultural vehicle with the parameter at the default setting, according to some embodiments.

In some embodiments, the processor transmits instructions to the control system 430 to transmit control signals to the implement system 436 to adjust the parameter of the agricultural vehicle to the default setting based on the determined attributes of the crop to be harvested. Once the default setting is established, the agricultural vehicle is operated with the parameter at the default setting.

Step 810 includes receiving an input of a user to adjust the setting of the parameter, according to some embodiments.

The default setting of the parameter may be adjusted based on feedback from previous operations or new information about the crop as input by the operator through input device 412. New information about the crop may also be uploaded to database 456. These updates may result in a new default setting of the parameter. For example, if it is discovered that the crop density is higher than expected, the default setting of the parameter can be adjusted to increase the cutting speed of the vehicle or reduce the height of the cutting blade. This ensures that the agricultural vehicle is optimized for the specific crop. However, adjustments to the setting of the parameter need not replace the default setting. For example, an operator may wish to set a custom setting but keep the default setting.

Step 812 includes storing the adjusted setting of the parameter as a secondary (i.e., custom) setting, according to some embodiments. Once the operator adjusts the parameter, the custom setting of the parameter is saved in the database 456. In some embodiments, database 456 is stored in memory 408, in other embodiments, database 456 is hosted remotely on a server and in communication with the processor through network 448.

Step 814 includes and upon thereafter receiving a second indication of the crop to be harvested, displaying the default setting and the secondary setting, according to some embodiments.

According to some embodiments, after the processor 406 receives an indication that the crop is to be harvested again, it displays the default setting and the secondary setting on the out device (e.g., a display). This allows the user to compare the default setting, which was established based on the determined attribute of the crop, and the secondary setting, which was adjusted by the user during the previous harvesting operation.

Displaying the default setting and the secondary setting gives the user the opportunity to evaluate the previous adjustment made and determine if it is appropriate for the subsequent harvest. The user can then select the best setting for the second harvest, based on factors such as the type of crop, the growth stage, and the environmental conditions.

By displaying the default setting and the secondary setting, the control system provides the user with greater flexibility and control over the harvesting process. This can lead to improved efficiency, higher crop yield, and reduced costs associated with inefficiencies or crop damage.

Furthermore, the displayed settings can be used to provide data for future harvesting operations. The control system can collect and store this information, allowing the system to adjust the default and secondary settings in the future based on the historical data collected.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a vehicle, a Global Positioning System (GPS) receiver, etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user. Other kinds of devices may be used to provide for interaction with a user as well; for example, feedback provided to the user may be any form of sensory feedback (e.g., visual feedback, auditory feedback, or tactile feedback).

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

It is important to note that the construction and arrangement of the vehicle 10 and the systems and components thereof (e.g., the driveline 50, the braking system 92, the control system 200, etc.) as shown in the various exemplary embodiments is illustrative only. Additionally, any element disclosed in one embodiment may be incorporated or utilized with any other embodiment disclosed herein.

1. A system comprising:
an agricultural vehicle;
a database;
a control system comprising processing circuitry configured to:
receive an indication of a crop to be harvested by the agricultural vehicle;
determine at least one attribute of the crop to be harvested by the agricultural vehicle and a default setting of a parameter of the agricultural vehicle, at least one of the at least one attribute of the crop or the default setting of the parameter being stored in the database;
adjust the parameter of the agricultural vehicle to the default setting, the default setting based at least on the at least one attribute of the crop to be harvested;
operate the agricultural vehicle with the parameter at the default setting;
receive an input of a user to adjust the setting of the parameter;
store the adjusted setting of the parameter as a secondary setting; and
upon thereafter receiving a second indication of the crop to be harvested, display the default setting and the secondary setting.

2. The system of claim 1, wherein the agricultural vehicle is one of a self-propelled windrower or towed mower-conditioner.

3. The system of claim 1, wherein receiving the indication of the crop to be harvested by the agricultural vehicle comprises receiving a user input from a display of the agricultural vehicle.

4. The system of claim 1, wherein the receiving the indication of the crop to be harvested by the agricultural vehicle includes receiving, by the processing circuitry, an image data from a sensor, analyzing the image data, and determining the crop based at least on the image data.

5. The system of claim 1, wherein the database is hosted by the processing circuitry, the processing circuitry hosted locally on the agricultural vehicle.

6. The system of claim 1, wherein the database is hosted by a server, the server remote to the agricultural vehicle.

7. The system of claim 1, wherein the at least one attribute of the crop is one of a type of the crop, a height, an age, a diameter of a stalk, an angle of the crop, a color, spacing, movement, root depth, species, germination period, growth stage, moisture content, structural integrity, calculated harvest loss, planted date, soil fertilizer content, and temperature.

8. The system of claim 1, wherein the parameter of the agricultural vehicle includes one of header height, a header tilt angle, a header roll angle, an auger speed, a roller speed, a knife speed, a disc speed, a roll gap, a roll tension, a vehicle speed, and a reel speed.

9. The system of claim 1, wherein adjusting the parameter of the agricultural vehicle includes automatically transmitting, by the processing circuitry, a control signal to at least one actuator of the agricultural vehicle.

10. The system of claim 1, wherein the agricultural vehicle is one of a plurality of agricultural vehicles in a fleet, wherein the plurality of agricultural vehicles have access to the default setting and the secondary setting.

11. A method comprising
receiving, by a processing circuitry, an indication of a crop to be harvested by an agricultural vehicle;
determining, by the processing circuitry, at least one attribute of the crop to be harvested by the agricultural vehicle and a default setting of a parameter of the agricultural vehicle, at least one of the at least one attribute of the crop or the default setting of the parameter being stored in a database;
adjusting, by the processing circuitry, the parameter of the agricultural vehicle to the default setting, the default setting based at least on the at least one attribute of the crop to be harvested;
operating, by the processing circuitry, the agricultural vehicle with the parameter at the default setting;
receiving, by the processing circuitry, an input of a user to adjust the setting of the parameter;
storing, by the processing circuitry, the adjusted setting of the parameter as a secondary setting; and
upon thereafter receiving, by the processing circuitry, a second indication of the crop to be harvested, displaying, by the processing circuitry, the default setting and the secondary setting.

12. The method of claim 11, wherein the agricultural vehicle is one of a self-propelled windrower or towed mower-conditioner.

13. The method of claim 11, wherein receiving the indication of the crop to be harvested by the agricultural vehicle comprises receiving, by the processing circuitry, a user input from a display of the agricultural vehicle.

14. The method of claim 11, wherein the receiving the indication of the crop to be harvested by the agricultural vehicle comprises:
receiving, by the processing circuitry, an image data from a sensor;
analyzing, by the processing circuitry, the image data; and
determining, by the processing circuitry, the crop based at least on the image data.

15. The method of claim 11, wherein the database is hosted by the processing circuitry, the processing circuitry hosted locally on the agricultural vehicle.

16. The method of claim 11, wherein the database is hosted by a server, the server remote to the agricultural vehicle.

17. The method of claim 11, wherein the at least one attribute of the crop is one of a type of the crop, a height, an age, a diameter of a stalk, an angle of the crop, a color, spacing, movement, root depth, species, germination period, growth stage, moisture content, structural integrity, calculated harvest loss, planted date, soil fertilizer content, and temperature.

18. The method of claim 11, wherein the parameter of the agricultural vehicle includes one of header height, a header tilt angle, a header roll angle, an auger speed, a roller speed, a knife speed, a disc speed, a roll gap, a roll tension, a vehicle speed, and a reel speed.

19. The method of claim 11, wherein adjusting the parameter of the agricultural vehicle includes automatically transmitting, by the processing circuitry, a control signal to at least one actuator of the agricultural vehicle.

20. The method of claim 11, wherein the agricultural vehicle is one of a plurality of agricultural vehicles in a fleet, wherein the plurality of agricultural vehicles have access to the default setting and the secondary setting.
